(19) United States
(12) Patent Application Publication
(10) Pub. No.: US 2005/0196634 A1
(43) Pub. Date: Sep. 8, 2005

(54) Metal member and electric contact using same

(75) Inventors: Naoki Abe, Hanyu-shi (JP); Masayuki Nishina, Honjo-shi (JP); Hiroshi Miyazawa, Honjo-shi (JP)

Correspondence Address: BACHMAN & LAPOINTE, P.C., 900 CHAPEL STREET, SUITE 1201, NEW HAVEN, CT, 06510, US

(73) Assignee: DOWA MINING CO., LTD.

(21) Appl. No.: 11/071,816

(22) Filed: Mar. 3, 2005

(30) Foreign Application Priority Data
Mar. 5, 2004 (JP) 2004-061650

(51) Int. Cl. B32B 15/18

(52) U.S. Cl. 428/615; 428/637; 428/655

(57) ABSTRACT

A metal member includes: a metal base; a first plating layer of nickel and unavoidable impurities, which is formed on the metal base; a second plating layer of nickel, phosphorus and unavoidable impurities, which is formed on the first plating layer; a third plating layer of a gold alloy and unavoidable impurities, which is formed on the second plating layer; and a fourth layer formed on the third plating layer by a sealing process, wherein the first plating layer has a thickness of 0.5 to 2.5 μm and the second plating layer has a thickness of 0.05 to 0.5 μm, the sum of the thickness of the first plating layer and the thickness of the second plating layer being in the range of from 0.60 μm to 2.5 μm, and the third plating layer having a thickness of not less than 0.05 μm.

### BACKGROUND OF THE INVENTION

1. Field of the Invention

The present invention generally relates to a metal member for use in electric contacts, such as switches and connectors, and an electric contact using the same. More specifically, the invention relates to a metal member for use in slidable electric contacts, and an electric contact using the same.

2. Description of the Prior Art

Of electric contacts (portions of movable and fixed members on which mechanical contact and electric conduction are carried out), such as low-current (signaling system) switches and connectors, for use in electrical equipments and electronics, electric contacts repeatedly used at a low contact load of 100 g or less are required to have a high connection reliability. Therefore, as such an electric contact, there is typically used an electric contact wherein the surface of a conductive metal member is coated with a noble metal.

At present, as such a typical electric contact coated with a noble metal, there is known an electric contact wherein a nickel plating underlayer having a thickness of 1 to 3 μm is formed on a metal member, and a layer of a gold alloy having a high wear resistance, such as AuCo alloy, having a thickness of 0.1 to 0.5 μm is formed thereon as a finished plating layer for decreasing its contact resistance, the gold alloy layer being sealed for improving its corrosion resistance and lubricity, and such an electric contact can ensure a long contact life (see, e.g., Japanese Patent Laid-Open No. 7-258891).

In general, contacts are classified broadly into butt contacts and slidable contacts on the basis of contact type. Of slidable contacts, there are some cases where slidable contacts for use in connectors for cards, encoder switches, multi-function switches and motor commutators are required to have a long contact life of tens of thousands times to hundreds of thousands times or more.

In order to improve the wear resistance of metal members for use in such long life contacts, the thickness of the gold alloy layer is increased, and/or an inexpensive Pd alloy layer is substituted for a part of the gold alloy layer. In a typical specification using a Pd alloy, a nickel plating underlayer is formed on a metal member, and a PdNi plating layer is formed thereon in place of a gold alloy film, and a gold alloy layer having a high wear resistance, such as an AuCo alloy or AuNi alloy layer, is formed thereon as a finished plating layer to reduce its contact resistance to obtain a long life electric contact (see, e.g., Japanese Patent Publication No. 2-44106).

When a longer life of hundreds of thousands to millions times is required, there are some cases where there is used a clad material wherein a noble metal foil having a thickness of a few micrometers or more is bonded to a metal member by rolling.

It is put to practical use that an NiP alloy plating layer mainly containing Ni and P is formed as an intermediate plating layer. For example, if an NiP alloy plating layer having a thickness of 1 to 3 μm is used as an intermediate plating layer, strong corrosion-resistant effects can be obtained. Such a plating layer is widely used for providing decoration and/or preservation.

If an NiP alloy contains 10 wt % or more of phosphorus (P), it has a uniform amorphous structure, so that the corrosion resistance thereof is far higher than that of an NiP alloy containing less than 10 wt % of phosphorus. In addition, if an NiP alloy is heated at 380 to 400° C. for a short period of time, it has the maximum hardness to have an improved wear resistance regardless of the content of phosphorus. Therefore, NiP alloy plating layers are used as wear-resistant alloy plating layers in place of hard Cr plating layers (see, e.g., Japanese Patent Laid-Open Nos. 6-316773, 7-11478 and 7-41985).

For example, in order to improve the corrosion resistance of a noble metal plating for decoration, Japanese Patent Laid-Open No. 7-11478 discloses a method for producing a noble metal plating, the method comprising the steps of: electroplating a base material with nickel; processing the upper layer thereof in a nickel-phosphorus alloy plating solution, which uses phosphorous acid or phosphate as a phosphorus supply source, at a high current density of 8 to 20 A/dm² as an initial current density and subsequently at a current density of 7 A/dm² or less; and forming a noble metal plating layer on the upper layer thereof.

For electric contacts, an NiP alloy plating layer is used as an intermediate layer under a surface plating layer of a noble metal particularly in the case of electroless plating or barrel plating (see, e.g., Japanese Patent Laid-Open Nos. 1-132072, 11-317253, 9-252070, 2000-313991, 2001-3192, 2001-89895 and 2001-342593).

For example, Japanese Patent Laid-Open No. 9-252070 discloses a lead frame which comprises: a lead frame base material; a first plating layer of Ni or an Ni alloy formed on the lead frame base material; a second plating layer of an NiP, NiB or NiCo alloy formed on the first plating layer so as to have a thickness of 0.02 to 0.3 μm; and a third plating layer of Au having a purity of 99.9% formed on the second plating layer so as to have a thickness of 0.2 μm or less, and also discloses that such a lead frame has excellent semiconductor element pellet-attachability, solder wettability and Au wire bonding characteristic even after a heat history is applied thereto.

In addition, Japanese Patent Laid-Open No. 2000-313991 discloses Au or Au alloy plating materials for electronic pats, which comprise an intermediate alloy plating layer consisting 0.05 to 20 wt % of phosphorus, nickel and unavoidable impurities, and a surface plating layer of Au or an Au alloy, in order to improve the heat resistance and corrosion resistance of Au or Au alloy materials used as contact portions for electronic parts.

However, NiP alloy plating films are low toughness and brittle films although they have an excellent corrosion resistance due to the dense film structure thereof and an excellent wear resistance due to the high hardness of 500 Hv or more thereof. If an NiP alloy plating film is thin so as to have a thickness of 1 μm or less, when a load, such as a bending stress, is applied thereto, there are problems in that cracks may be easily produced therein to deteriorate the corrosion resistance and wear resistance thereof, and that the NiP alloy plating film may be peeled off if the worst comes to the worst. In addition, if an NiP alloy plating layer serving as an intermediate layer is thick, there are critical defects for practical use that a die is remarkably worn during molding or punching and that it is impossible to carry out working itself if the worst comes to the worst. Therefore, NiP alloy plating films are only applied to parts which are not required to carry out any mechanical secondary working.

In addition, the film structures disclosed in Japanese Patent Laid-Open Nos. 7-11478 and 9-252070 can not sufficiently increase the life of electric contacts since the third plating layer is an Au alloy layer and a sealing layer serving as a fourth layer is not provided.

Moreover, it is described in Japanese Patent Laid-Open No.2000-313991 that a sealing process is preferably carried out with any one of various inorganic or organic sealing solutions in order to facilitate insertion and extraction and that there is no problem if a plating layer of copper or the like exists between an intermediate layer containing nickel and a base material. However, the plating material disclosed in Japanese Patent Laid-Open No. 2000-313991 is not insufficient to provide a high corrosion resistance although it is possible to improve the heat resistance and corrosion resistance of electric contacts.

In particular, long life contacts, such as connecters for cards, are required to have a longer life and to reduce costs while reducing the amount of noble metals to be used.

### SUMMARY OF THE INVENTION

It is therefore an object of the present invention to eliminate the aforementioned problems and to provide a metal member having an excellent wear resistance, the metal member being capable of reducing the amount of noble metals, such as Au and Pd, to be used and capable of increasing the life of an electric contact using the same, and an electric contact using the same.

In order to accomplish the aforementioned and other objects, the inventors have diligently studied and found that it is possible to provide a metal member having a wear resistance equal to or higher than that of conventional metal members, the metal member being capable of produced at relatively low costs by reducing the amount of expensive noble metals to be used, if the metal member comprises: a metal base; a first plating layer of nickel and unavoidable impurities, which is formed on the metal base; a second plating layer of nickel, phosphorus and unavoidable impurities, which is formed on the first plating layer; a third plating layer of a gold alloy and unavoidable impurities, which is formed on the second plating layer; and a fourth layer formed on the third plating layer by a sealing process, wherein the first plating layer has a thickness (T1) of 0.5 to 2.5 μm and the second plating layer has a thickness (T2) of 0.05 to 0.5 μm, the sum (T1+T2) of the thickness of the first plating layer and the thickness of the second plating layer being in the range of from 0.60 μm to 2.5 μm, and the third plating layer having a thickness of not less than 0.05 μm. Thus, the inventors have made the present invention.

According one aspect of the present invention, a metal member comprises: a metal base; a first plating layer of nickel and unavoidable impurities, the first plating layer being formed on the metal base; a second plating layer of nickel, phosphorus and unavoidable impurities, the second plating layer being formed on the first plating layer; a third plating layer of a gold alloy and unavoidable impurities, the third plating layer being formed on the second plating layer; and a fourth layer formed on the third plating layer by a sealing process, wherein the first plating layer has a thickness of 0.5 to 2.5 μm, and the second plating layer has a thickness of 0.05 to 0.5 μm, the sum of the thicknesses of the first and second plating layers being in the range of from 0.60 μm to 2.5 μm, and the third plating layer having a thickness of not less than 0.05 μm.

In this metal member, the first plating layer may be a nickel plating layer formed by a sulfamic acid bath or by a Watt's bath to which a primary brightener containing a sulfur content is added.

According to another aspect of the present invention, an electric contact comprises: a first terminal of the above described metal member as; and a second terminal contacting the first terminal.

According to the present invention, it is possible to provide a metal member having an excellent wear resistance, the metal member being capable of reducing the amount of noble metals, such as Au and Pd, to be used and capable of increasing the life of an electric contact using the same, and an electric contact using the same.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a sectional view schematically showing a preferred embodiment of a metal member according to the present invention;

FIG. 2 is a schematic diagram of an electric contact using a terminal of a preferred embodiment of a metal member according to the present invention; and

FIG. 3 is a graph showing the relationship between the total thickness (T1+T2) of the first and second plating layers, and the width of cracks produced by bending.

### DESCRIPTION OF THE PREFERRED EMBODIMENTS

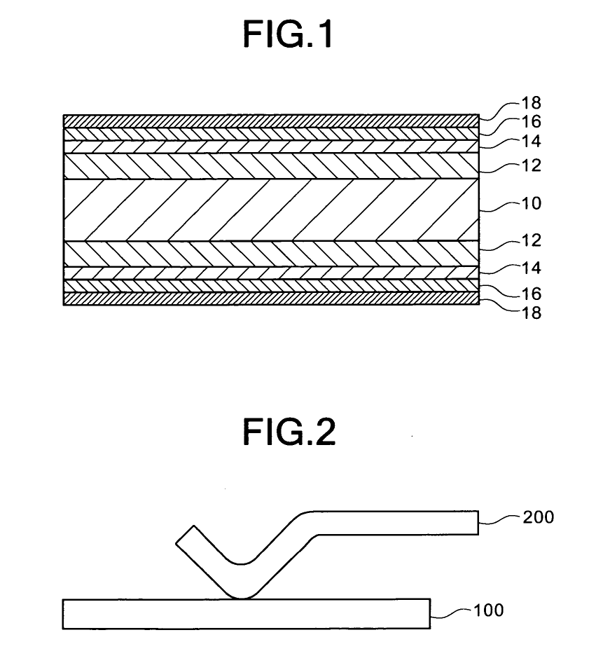

As shown in FIG. 1, a preferred embodiment of a metal member according to the present invention comprises: a metal base 10; a first plating layer 12 of nickel and unavoidable impurities, which is formed on the surface of the metal base 10; a second plating layer 14 of nickel, phosphorus and unavoidable impurities, which is formed on the first plating layer 12; a third plating layer 16 of a gold alloy and unavoidable impurities, which is formed on the second plating layer 14; and a fourth layer 18 formed on the third plating layer 16 by a sealing process, wherein the first plating layer 12 has a thickness (T1) of 0.5 μm to 2.5 μm and the second plating layer 14 has a thickness (T2) of 0.05 to 0.5 μm, the sum (T1+T2) of the thickness of the first plating layer 12 and the thickness of the second plating layer 14 being in the range of from 0.60 μm to 2.5 μm, and the third plating layer 16 having a thickness of not less than 0.05 μm.

The metal base is preferably made of copper having excellent conductivity and spring characteristics, a copper alloy, such as brass, phosphor bronze, beryllium bronze or nickel silver, or stainless. The shape of the base metal may be any shape, such as a plate shape or a punched bar.

On the surface of the metal base, a first plating layer of nickel and unavoidable impurities, a second plating layer of nickel, phosphorus and unavoidable impurities, and a third plating layer of a gold alloy and unavoidable impurities are sequentially formed, and a sealing process using an inorganic or organic processing solution generally called a sealing agent is carried out to form a fourth layer on the third plating layer.

The first plating layer of nickel and unavoidable impurities can be formed by electroplating using a well-known nickel plating bath. In order to form a plating underlayer between the metal base and an intermediate plating layer, a Wood's bath is generally used as a nickel electroplating bath. However, a nickel sulfamate bath, or a Watt's bath to which a primary brightener containing sulfur contents is added, is preferably used as a nickel electroplating bath. Throughout the specification, the term “unavoidable impurities” means components based on eluate components from the plating bath, raw materials and the base metal.

The first plating layer containing nickel as a main component is an essential plating layer in order to eliminate disadvantages when an NiP alloy plating layer is used as a single intermediate layer and in order to increase the life of a slidable electric contact. That is, the first plating layer is an essential plating layer, first, in order to disperse and relax a load stress between fine protrusions on a contact portion during sliding wear by smoothing the surface roughness of the metal base, and secondly, in order to avoid the brittle fracture of an NiP alloy film during sliding wear while improving machinability by providing a layer having a higher hardness than that of the base metal and having a higher toughness than that of the NiP alloy.

In order to accomplish such objects, the plating film is preferably a plating film containing nickel as a main component, and more preferably a plating film formed in a sulfamic acid bath or a Watt's bath to which a primary brightener containing sulfur contents is added. If a nickel plating is carried out in any one of these baths, the film is caused to contain sulfur contents, so that stress in electrode posits is relaxed. Therefore, even if the nickel plating layer is thick, it is easy to ensure a desired adhesion between the plating layer and the base metal, so that it is possible to improve workability when machining is carried out. In addition, even if the film has a high hardness of 300 to 500 Hv, it is possible to maintain an extension of about 5%. On the other hand, a copper plating film has only a hardness of about 150 Hv, and is not preferably used as the first plating layer.

A typical composition of the nickel sulfamate bath comprises 300 to 600 g/L of nickel sulfamate, 0 to 30 g/L of nickel chloride, 30 to 40 g/L of boric acid and an optimum amount of additive. As the additive, a pit inhibitor or a stress relaxation agent is preferably used. Typical plating conditions contain a PH of 3.5 to 4.5, a bath temperature of 40 to 60° C., and a current density of 2 to 40 A/dm².

A typical composition of the Watt's bath comprises 240 to 300 g/L of nickel sulfate, 45 to 50 g/L of nickel chloride, 30 to 40 g/L of boric acid and an optimum amount of additive. As the additive, a primary brightener, a secondary brightener or a pit inhibitor is preferably used. Particularly as a stress relaxation agent, a primary brightener containing sulfur contents is preferably used. Typical plating conditions contain a pH of 4.0 to 4.5, a bath temperature of 45 to 60° C. and a current density of 2 to 8 A/dm².

The thickness of the first plating layer is preferably in the range of from 0.5 μm to 3.0 μm. If the thickness of the first plating layer is less than 0.5 μm, the function of improving wear resistance is insufficient. On the other hand, if the thickness of the first plating layer exceeds 3 μm, the electroplating rate is a rate limiting factor to deteriorate productivity. In addition, the hardness of the first plating layer is too high, so that press workability deteriorates.

The second plating layer of nickel, phosphorus and unavoidable impurities may be formed by electroplating using a well-known NiP alloy plating bath, such as a Brenner bath or a low phosphorus bath.

A typical composition of the Brenner bath comprises 150 g/L of nickel sulfate, 45 g/L of nickel chloride, 50 g/L of orthophosphoric acid and 40 g/L of phosphorous acid. Typical plating conditions contain a pH of 0.5 to 1.0, a bath temperature of 75 to 95° C. and a current density of 5 to 40 A/dm².

A typical composition of the low phosphorus bath comprises 150 to 200 g/L of nickel sulfate, 5 to 50 g/L of orthophosphoric acid, 20 g/L of sodium chloride, 20g/L of boric acid and 20 to 30 g/L of sodium hypophosphite. Typical plating conditions contain a pH of 2.0 to 2.5, a bath temperature of 70 to 80° C. and a current density of 5 to 15 A/dm².

In any one of the above described baths, phosphorous acid or sodium hypophosphite is consumed in proportion to the amount of electrode position, to vary the current efficiency and the content of phosphorus, so that it is required to pay attention to the control of the composition of the bath. If the content of phosphorus in the NiP alloy film is not less than 1 wt %, the function of improving wear resistance can be obtained. On the other hand, the content of phosphorus in the NiP alloy film exceeds 15 wt %, the current efficiency remarkably decreases, so that it is not put to practical use. Therefore, the content of phosphorus in the NiP alloy film is preferably in the range of from 1 wt % to 15 wt %.

The thickness of the second plating layer is preferably in the range of from 0.05 μm to 0.3 μm, and the sum of the thickness of the first plating layer and the thickness of the second plating layer is preferably in the range of from 0.6 μm to 3.1 μm. If the thickness of the second plating layer and the sum are less than the above described lower limits, the function of improving wear resistance is insufficient. On the other hand, if the thickness of the second plating layer and the sum exceed the above described upper limits, the electroplating rate is a rate limiting factor to deteriorate productivity. In addition, the hardness of the second plating layer is too high, so that press workability deteriorates.

The Au alloy layer serving as the third plating layer may be a well-known Au alloy film. Gold is chemically stable, and can maintain a high conductivity even in a mechanochemical oxidizing environment during sliding wear. In addition, gold has excellent spreadability to have the function of inhibiting adhesion, so that it has the function of improving wear resistance. However, since the hardness of pure gold plating is too low, it is easy to cause adhesive wear, so that the were resistance of pure gold plating is insufficient. Therefore, an Au alloy plating having a high hardness is preferably used as the material of the third plating layer, and AuCo, AuNi or AuCu alloy may be used as the material of the third plating layer. In addition, a polymer formed in an Au alloy plating film, which is obtained in an acid bath containing an organic chelating agent, can serve as a lubricant to improve wear resistance. Therefore, such an Au alloy plating layer is preferably used.

The third plating layer is preferably formed on only a region, which is used as an electric contact, in order to reduce costs since it uses an expansive gold alloy. If it is required to consider workability in a secondary press working, the first and second plating layers may be formed on a necessary region, or plating layers having different thicknesses may be formed. In other words, it is not required to plate the whole region of the metal member, and at least a region used as an electric contact may be plated.

The third plating layer of the gold alloy and unavoidable impurities is formed in a gold alloy bath of an acidic cyanogen bath containing Co, Ni or Fe, and is preferably formed in an AuCo alloy plating bath. It is known that an AuCo alloy plating forms an eutectoid of 0.1 to 0.3 wt % of Co and a polymer containing C, N, K, H and O to serve as a lubricant due to the presence of the polymer to have excellent lubrication. A typical composition of the bath comprises 5 to 30 g/L of gold potassium cyanide, 80 to 150 g/L of citric acid and/or potassium citrate, 0.2 to 0.5 g/L of a Co salt serving as metal Co, and optimum amounts of chelating agent and additive.

The thickness of the third plating layer is preferably 0.05 μm or more. If the thickness of the third plating layer is less than 0.05 μm, it is not possible to obtain stable electric characteristics, so that wear resistance deteriorates.

The fourth layer is a nonmetal film formed by an inorganic or organic sealing agent. The fourth layer seals pinholes in the Au alloy plating film, which is the third plating layer, to improve corrosion resistance. In the fourth layer, the organic substance contained in the sealing agent serves as a lubricant to reduce frictional resistance during sliding to improve the life of the electric contact.

The fourth layer is formed by a sealing process with an inorganic or organic processing solution generally called a sealing agent. Various sealing agents (lubricators) are commercially available. As examples of compositions thereof, there are used asphaltic amines, aromatic amines, diamines, polyamines, amino alcohols, monocarboxylic acid amides, oximes, pyridine, quinoline, azo compounds, hydroxycarboxylic acids, thiouric acid, thiosemicarbazide, monosaccharides, imidazole, benzimidazole, triazole, benzotriazole, triazine, oxazole, oxazine, thiazole, benzothiazole, naphthalene, and compounds of In, Zn, Cd, Cr, Pd, Rh, Sn, Be, Al, Th and Zr. It is required to choose a sealing agent on the basis of past results of use as a sliding electric contact and on the basis of validation of actual sliding tests.

Industrially, as a system capable of continuously carrying out the above described processes, there is preferably used a reel-to-reel or hoop type continuous electroplating system.

Furthermore, as shown in FIG. 2, the above described preferred embodiment of a metal member according to the present invention may be used for forming a first terminal 100 which is designed to contact a second terminal 200 to form an electric contact. In this case, the plating layers in the above described preferred embodiment of a metal member according to are not required to be formed on the whole surface of the first terminal 100, and may be formed on only a contact portion of the first terminal 100.

Examples of a metal member according to the present invention will be described below in detail.

### EXAMPLE 1

After a copper plate (C1201P) having a size of 60 mm×60 mm×0.3 mm was prepared as a metal base to pretreated, Ni plating, Cu plating, Ni—P plating and AuCo plating were sequentially carried out, and thereafter, a sealing process was carried out to produce a metal member. These processes will be described below.

### Pretreatment

The above described copper plate was immersed in an alkali degreasing solution, and a voltage of 5 V was applied thereto for two minutes to carry out an electrolytic degreasing process. Thereafter, the copper plate was taken out of the degreasing solution to be washed with pure water. Then, the copper plate was immersed in an aqueous solution containing 5 wt % of sulfuric acid for thirty seconds to carry out an acid cleaning process. Thereafter, the copper plate was taken out of the aqueous sulfuric acid solution to be washed with pure water again.

### Ni Plating

Then, the copper plate thus pretreated and an Ni plate were immersed in a plating bath containing nickel sulfamate (the content of Ni: 100 g/L), nickel chloride (the content of Ni: 15 g/L), boric acid (80 g/L) and a brightening agent (SN1000 (10 mL/L) produced by Murata Co., Ltd.). The copper plate was used as a cathode, and the Ni plate was used as an anode. Then, the bath was held at a temperature of 50° C. and at a pH of 4.0, and the current density was set to be 5.0 A/dm². In these conditions, an Ni film was deposited on the copper plate so as to have a thickness of 1.0 μm by controlling the electrolysis time.

### Ni—P Plating

Then, the copper plate thus plated with Ni and an Ni plate serving as an anode were immersed in a plating bath containing nickel sulfate (200 g/L), sodium hypophosphite (20 g/L), boric acid (20 g/L), sodium chloride (20 g/L) and phosphoric acid (5 mL). The bath was held at a temperature of 70° C. and at a pH of 2.3, and the current density was set to be 6.0 A/dm². In these conditions, an NiP alloy film was deposited on the Ni plating layer so as to have a thickness of 0.10 μm by controlling the electrolysis time.

### AuCo Plating

Then, anAuCo alloy bath containing gold potassium cyanide (the content of Au: 6 g/L) and a predetermined amount of additive (AUTOBRIGHT HS-5, BA, BB produced by Nippon Kojundo Kagaku Co., Ltd.) was prepared as a plating bath. In this plating bath, the copper plate plated with Ni—P and a Pt coated Ti electrode serving as an anode were immersed. The bath was held at a temperature of 50° C. and at a pH of 4.0, and the current density was set to be 0.72 A/dm². In these conditions, an AuCo alloy film was deposited on the Ni—P plating layer-so as to have a thickness of 0.10 μm by controlling the electrolysis time.

### Sealing Process

Then, a sealing agent (KD-Au100W produced by Chemical Electronics Company, Inc.) was diluted with pure water so as to have a concentration of 200 mL/L. The diluent thus obtained was held at a temperature of 60° C., and the copper plate plated with AuCo was immersed therein for ten seconds to carry out a sealing process.

The metal member was produced by the above described processes, and used as a test piece for evaluating wear resistance, bending workability and apparent film hardness. The evaluation methods thereof will be described below.

### Evaluation of Wear Resistance

A SUS indenter having a spherical tip having a diameter of 5 mm was stood on the test piece perpendicularly thereto, and a load of 50 g was applied to the test piece in an axial direction of the indenter. In this state, the indenter was linearly reciprocated on the same trajectory on the surface of the test piece to carry out a sliding test. At that time, the sliding distance of the indenter was set to be constant (12.5 mm), and the reciprocating speed thereof was set to be 60 Hz. After the sliding test, scars made by wear on the test piece were observed by a super depth microscope, and the width of a scar made by wear (which will be hereinafter referred to as a “wear scar width”) in directions perpendicular to the sliding directions was measured. As the wear scar width is narrower, wear resistance is more excellent. As a result, in this example, the wear scar width after ten thousand reciprocating motions was 0.11 mm, the wear scar width after forty thousand reciprocating motions was 0.13 mm, and the wear scar width after two hundred thousand reciprocating motions was 0.14 mm.

### Evaluation of Bending Workability

After the test piece was folded by 90 degrees at R=3.0, cracks produced on the folded portion were observed by a super depth microscope to measure the widths of cracks within a normal visual field, and the mean value thereof was assumed as a mean crack width. It can be determined that bending workability is more excellent as the mean crack width is narrower. As a result, in this example, the mean crack width was 10.8 μm.

### Evaluation of Apparent Film Hardness

As a method for evaluating characteristics substituting for press workability, the apparent film hardness of the test piece was measured by the Vickers hardness test. In this measurement, the hardness of the whole metal member, i.e., the apparent film hardness of the test piece, was obtained by applying such a load that the indenter sufficiently reaches the base material, specifically, by applying a load of 100 gf for 15 seconds. It can be determined that press workability is more excellent as the apparent film hardness is lower. As a result, in this example, the apparent film hardness was 102 Hv.

### EXAMPLE 2

By the same method as that in Example 1, except that the thickness of the Ni film was 0.5 μm, a metal member was produced, and the wear resistance, bending workability and apparent film hardness thereof were evaluated. As a result, the wear scar width after forty thousand reciprocating motions was 0.10 mm, the mean crack width was 9.8 μm, and the apparent film hardness was 98 Hv.

### EXAMPLE 3

By the same method as that in Example 1, except that the thickness of the Ni film was 0.5 μm and the thickness of the NiP film was 0.20 μm, a metal member was produced, and the wear resistance, bending workability and apparent film hardness thereof were evaluated. As a result, the wear scar width after forty thousand reciprocating motions was 0.12 mm, the mean crack width was 9.1 μm, and the apparent film hardness was 99 Hv.

### EXAMPLE 4

By the same method as that in Example 1, except that the thickness of the NiP film was 0.05 μm, a metal member was produced, and the wear resistance, bending workability and apparent film hardness thereof were evaluated. As a result, the wear scar width after forty thousand reciprocating motions was 0.13 mm, the mean crack width was 9.1 μm, and the apparent film hardness was 108 Hv.

### EXAMPLE 5

By the same method as that in Example 1, except that the thickness of the NiP film was 0.50 μm, a metal member was produced, and the wear resistance, bending workability and apparent film hardness thereof were evaluated. As a result, the wear scar width after forty thousand reciprocating motions was 0.12 mm, the mean crack width was 9.8 μm, and the apparent film hardness was 106 Hv.

### EXAMPLE 6

By the same method as that in Example 1, except that the thickness of the AuCo alloy film was 0.05 μm, a metal member was produced, and the wear resistance thereof was evaluated. As a result, the wear scar width after forty thousand reciprocating motions was 0.13 mm.

### EXAMPLE 7

By the same method as that in Example 1, except that the thickness of the AuCo alloy film was 0.30 μm, a metal member was produced, and the wear resistance thereof was evaluated. As a result, the wear scar width after forty thousand reciprocating motions was 0.11 mm.

### EXAMPLE 8

By the same method as that in Example 1, except that the thickness of the Ni film was 2.0 μm and the thickness of the NiP film was 0.05 μm, a metal member was produced, and the wear resistance thereof was evaluated. As a result, the wear scar width after forty thousand reciprocating motions was 0.12 mm.

### EXAMPLE 9

By the same method as that in Example 1, except that the thickness of the Ni film was 2.0 μm, a metal member was produced, and the wear resistance, bending workability and apparent film hardness thereof were evaluated. As a result, the wear scar width after forty thousand reciprocating motions was 0.14 mm, the mean crack width was 11.3 μm, and the apparent film hardness was 108 Hv.

### EXAMPLE 10

By the same method as that in Example 1, except that the thickness of the Ni film was 2.0 μm and the thickness of the NiP film was 0.50 μm, a metal member was produced, and the wear resistance, bending workability and apparent film hardness thereof were evaluated. As a result, the wear scar width after forty thousand reciprocating motions was 0.10 mm, the mean crack width was 15.4 μm, and the apparent film hardness was 116 Hv.

### EXAMPLE 11

By the same method as that in Example 1, except that the Ni plating was carried out in a Watt's bath using a primary brightener, a metal member was produced, and the wear resistance and apparent film hardness thereof were evaluated. In the Ni plating in the Watt's bath using the primary brightener, a copper plate pretreated by the same method as that in Example 1 and an Ni plate were immersed in a plating bath which comprises nickel sulfate (300 g/L), nickel chloride (45 g/L), boric acid (40 g/L) and a brightener (LIEVERIGHT SB-71 (1.5 mL/L) and SB-72 (1.5 mL/L) produced by World Metal Co., Ltd.). The copper plate was used as a cathode, and the Ni plate was used as an anode. The bath was held at a temperature of 50° C. and at a pH of 4.2, and the current density was set to be 5.0 A/dm². In these conditions, an Ni film was deposited on the copper plate so as to have a thickness of 1.0 μm by controlling the electrolysis time. As a result, the wear scar width after forty thousand reciprocating motions was 0.14 mm, the wear scar width after two hundred thousand reciprocating motions was 0.18 mm, and the apparent film hardness was 103 Hv.

### COMPARATIVE EXAMPLE 1

By the same method as that in Example 1, except that the Ni—P plating was not carried out, a metal member was produced, and the wear resistance, bending workability and apparent film hardness thereof were evaluated. As a result, the wear scar width after ten thousand reciprocating motions was 0.15 mm, and the wear scar width after forty thousand reciprocating motions was 0.88 mm. In addition, the mean crack width was 7.8 μm, and the apparent film hardness was 112 Hv.

### COMPARATIVE EXAMPLE 2

By the same method as that in Example 1, except that the thickness of the Ni film was 3.0 μm and the Ni—P plating was not carried out, a metal member was produced, and the wear resistance, bending workability and apparent film hardness thereof were evaluated. As a result, the wear scar width after ten thousand reciprocating motions was 0.10 mm, and the wear scar width after forty thousand reciprocating motions was 0.78 mm. In addition, the mean crack width was 48.1 μm, and the apparent film hardness was 133 Hv.

### COMPARATIVE EXAMPLE 3

By the same method as that in Example 1, except that a PdNi alloy plating layer having a thickness of 0.50 μm was formed in place of the Ni—P plating layer, a metal member was produced, and the wear resistance, bending workability and apparent film hardness thereof were evaluated. As a result, the wear scar width after forty thousand reciprocating motions was 0.15 mm, and the wear scar width after two hundred thousand reciprocating motions was 0.14 mm. In addition, the mean crack width was 7.3 μm, and the apparent film hardness was 103 Hv.

### COMPARATIVE EXAMPLE 4

By the same method as that in Example 1, except that the thickness of the Ni film was 3.0 μm and a PdNi alloy plating layer having a thickness of 0.50 μm was formed in place of the Ni—P plating layer, a metal member was produced, and the wear resistance, bending workability and apparent film hardness thereof were evaluated. As a result, the wear scar width after ten thousand reciprocating motions was 0.11 mm, the wear scar width after forty thousand reciprocating motions was 0.15 mm, and the wear scar width after two hundred thousand reciprocating motions was 0.16 mm. In addition, the mean crack width was 37.1 μm, and the apparent film hardness was 136 Hv.

### COMPARATIVE EXAMPLE 5

By the same method as that in Example 1, except that the Ni plating was not carried out, a metal member was produced, and the wear resistance, bending workability and apparent film hardness thereof were evaluated. As a result, the wear scar width after forty thousand reciprocating motions was 0.60 mm, the mean crack width was 3.9 μm, and the apparent film hardness was 91 Hv.

### COMPARATIVE EXAMPLE 6

By the same method as that in Example 1, except that the Ni plating was not carried out and the thickness of the NiP layer was 0.50 μm, a metal member was produced, and the wear resistance, bending workability and apparent film hardness thereof were evaluated. As a result, the wear scar width after ten thousand reciprocating motions was 0.16 mm, and the wear scar width after forty thousand reciprocating motions was 0.57 mm. In addition, the mean crack width was 9.4 μm, and the apparent film hardness was 98 Hv.

### COMPARATIVE EXAMPLE 7

By the same method as that in Example 1, except that the Ni plating was not carried out and the thickness of the NiP layer was 1.00 μm, a metal member was produced, and the wear resistance, bending workability and apparent film hardness thereof were evaluated. As a result, the wear scar width after forty thousand reciprocating motions was 0.19 mm, and the wear scar width after two hundred thousand reciprocating motions was 0.85 mm. In addition, the mean crack width was 17.3 μm, and the apparent film hardness was 115 Hv.

### COMPARATIVE EXAMPLE 8

By the same method as that in Example 1, except that the Ni plating was not carried out and the thickness of the NiP layer was 2.00 μm, a metal member was produced, and the wear resistance, bending workability and apparent film hardness thereof were evaluated. As a result, the wear scar width after forty thousand reciprocating motions was 0.15 mm, and the wear scar width after two hundred thousand reciprocating motions was 0.31 mm. In addition, the mean crack width was 29.1 μm, and the apparent film hardness was 132 Hv.

### COMPARATIVE EXAMPLE 9

By the same method as that in Example 1, except that a Cu plating was substituted for the Ni plating, a metal member was produced, and the wear resistance and apparent film hardness thereof were evaluated. In the Cu plating, a copper plate pretreated by the same method as that in Example 1 and a phosphorus containing copper plate serving as an anode were immersed in a plating bath which comprises copper sulfate (250 g/L), sulfuric acid (40 g/L), a brightener (thiourea (0.01 g/L) and dextrin (0.01 g/L) ). The bath was held at a temperature of 40° C., and the current density was set to be 5.0 A/dm². In these conditions, a Cu film was deposited on the copper plate so as to have a thickness of 1.0 μm by controlling the electrolysis time. As a result, the wear scar width after forty thousand reciprocating motions was 0.48 mm, and the apparent film hardness was 96 Hv.

### COMPARATIVE EXAMPLE 10

By the same method as that in Example 1, except that the Ni plating was carried out in a Watt's bath using no primary brightener, a metal member was produced, and the wear resistance and apparent film hardness thereof were evaluated. As a result, the wear scar width after forty thousand reciprocating motions was 0.61 mm, and the apparent film hardness was 100 Hv.

### COMPARATIVE EXAMPLE 11

By the same method as that in Example 1, except that the Ni plating was carried out in a Watt's bath using no primary brightener, a metal member was produced, and the wear resistance and apparent film hardness thereof were evaluated. In the Ni plating in the Watt's bath using no primary brightener, a copper plate pretreated by the same method as that in Example 1 and an Ni plate were immersed in a plating bath which comprises nickel sulfate (300 g/L), nickel chloride (45 g/L) and boric acid (40 g/L). The copper plate was used as a cathode, and the Ni plate was used as an anode. The bath was held at a temperature of 50° C. and at a pH of 4.2, and the current density was set to be 5.0 A/dm². In these conditions, an Ni film was deposited on the copper plate so as to have a thickness of 1.0 μm by controlling the electrolysis time. As a result, the wear scar width after forty thousand reciprocating motions was 0.79 mm, and the apparent film hardness was 99 Hv.

### COMPARATIVE EXAMPLE 12

By the same method as that in Example 1, except that the thickness of the Ni film was 0.5 μm and the thickness of the NiP film was 0.05 μm, a metal member was produced, and the wear resistance and apparent film hardness thereof were evaluated. As a result, the wear scar width after forty thousand reciprocating motions was 0.32 mm, and the apparent film hardness was 100 Hv.

### COMPARATIVE EXAMPLE 13

By the same method as that in Example 1, except that the thickness of the Ni film was 3.0 μm, a metal member was produced, and the wear resistance, bending workability and apparent film hardness thereof were evaluated. As a result, the wear scar width after ten thousand reciprocating motions was 0.10 mm, the wear scar width after forty thousand reciprocating motions was 0.10 mm, and the wear scar width after two hundred thousand reciprocating motions was 0.14 mm. In addition, the mean crack width was 45.1 μm, and the apparent film hardness was 133 Hv.

### COMPARATIVE EXAMPLE 14

By the same method as that in Example 1, except that the thickness of the Ni film was 3.0 μm and the thickness of the NiP film was 0.30 μm, a metal member was produced, and the wear resistance, bending workability and apparent film hardness thereof were evaluated. As a result, the wear scar width after forty thousand reciprocating motions was 0.11 mm, the mean crack width was 44.4 μm, and the apparent film hardness was 133 Hv.

### COMPARATIVE EXAMPLE 15

By the same method as that in Example 1, except that the thickness of the Ni film was 0.1 μm and the thickness of the NiP film was 0.50 μm, a metal member was produced, and the wear resistance thereof was evaluated. As a result, the wear scar width after forty thousand reciprocating motions was 0.27 mm.

### COMPARATIVE EXAMPLE 16

By the same method as that in Example 1, except that the sealing process was not carried out, a metal member was produced, and the wear resistance thereof was evaluated. As a result, the wear scar width after forty thousand reciprocating motions was 0.16 mm, and the wear scar width after two hundred thousand reciprocating motions was 0.21 mm.

The results in the above described examples and comparative examples are shown in Tables 1 through 4.

TABLE 1

| | first | | | second | | third | | |
|---|---|---|---|---|---|---|---|---|
| | layer | | | layer | | layer | | fourth |
| | | | T | | T | | T | layer |
| | C | B | (μm) | C | (μm) | C | (μm) | SA |
| Ex. 1 | Ni | SMB | 1.0 | NiP | 0.10 | AuCo | 0.10 | KD-Au 100 W |
| Ex. 2 | Ni | SMB | 0.5 | NiP | 0.10 | AuCo | 0.10 | KD-Au 100 W |
| Ex. 3 | Ni | SMB | 0.5 | NiP | 0.20 | AuCo | 0.10 | KD-Au 100 W |
| Ex. 4 | Ni | SMB | 1.0 | NiP | 0.05 | AuCo | 0.10 | KD-Au 100 W |
| Ex. 5 | Ni | SMB | 1.0 | NiP | 0.50 | AuCo | 0.10 | KD-Au 100 W |
| Ex. 6 | Ni | SMB | 1.0 | NiP | 0.10 | AuCo | 0.05 | KD-Au 100 W |
| Ex. 7 | Ni | SMB | 1.0 | NiP | 0.10 | AuCo | 0.30 | KD-Au 100 W |
| Ex. 8 | Ni | SMB | 2.0 | NiP | 0.05 | AuCo | 0.10 | KD-Au 100 W |
| Ex. 9 | Ni | SMB | 2.0 | NiP | 0.10 | AuCo | 0.10 | KD-Au 100 W |
| Ex. | Ni | SMB | 2.0 | NiP | 0.50 | AuCo | 0.10 | KD-Au 100 W |
| 10 | | | | | | | | |
| Ex. | Ni | WTB | 1.0 | NiP | 0.10 | AuCo | 0.10 | KD-Au 100 W |
| 11 | | (b) | | | | | | |

C: composition
B: plating bath
T: thickness
SA: sealing agent
SMB: sulfamic acid bath
WTB: Watt's bath
b: containing brightener

TABLE 2

| | first | | | second | | third | | fourth |
|---|---|---|---|---|---|---|---|---|
| | layer | | | layer | | layer | | layer |
| | C | B | T (μm) | C | T (μm) | C | T (μm) | SA |
| Comp. 1 | Ni | SMB | 1.0 | — | 0.00 | AuCo | 0.10 | KD-Au 100 W |
| Comp. 2 | Ni | SMB | 3.0 | — | 0.00 | AuCo | 0.10 | KD-Au 100 W |
| Comp. 3 | Ni | SMB | 1.0 | PdNi | 0.50 | AuCo | 0.10 | KD-Au 100 W |
| Comp. 4 | Ni | SMB | 3.0 | PdNi | 0.50 | AuCo | 0.10 | KD-Au 100 W |
| Comp. 5 | — | — | 0.0 | NiP | 0.10 | AuCo | 0.10 | KD-Au 100 W |
| Comp. 6 | — | — | 0.0 | NiP | 0.50 | AuCo | 0.10 | KD-Au 100 W |
| Comp. 7 | — | — | 0.0 | NiP | 1.00 | AuCo | 0.10 | KD-Au 100 W |
| Comp. 8 | — | — | 0.0 | NiP | 2.00 | AuCo | 0.10 | KD-Au 100 W |
| Comp. 9 | Cu | SRB | 1.0 | NiP | 0.10 | AuCo | 0.10 | KD-Au 100 W |
| Comp. 10 | Ni | WOB | 1.0 | NiP | 0.10 | AuCo | 0.10 | KD-Au 100 W |
| | | (nb) | | | | | | |
| Comp. 11 | Ni | WTB | 1.0 | NiP | 0.10 | AuCo | 0.10 | KD-Au 100 W |
| | | (nb) | | | | | | |
| Comp. 12 | Ni | SMB | 0.5 | NiP | 0.05 | AuCo | 0.10 | KD-Au 100 W |
| Comp. 13 | Ni | SMB | 3.0 | NiP | 0.10 | AuCo | 0.10 | KD-Au 100 W |
| Comp. 14 | Ni | SMB | 3.0 | NiP | 0.30 | AuCo | 0.10 | KD-Au 100 W |
| Comp. 15 | Ni | SMB | 0.1 | NiP | 0.50 | AuCo | 0.10 | KD-Au 100 W |
| Comp. 16 | Ni | SMB | 1.0 | NiP | 0.10 | AuCo | 0.10 | — |

SRB: sulfuric acid bath
WOB: Wood's bath
nb: containing no brightener

TABLE 3

| | wear scar width | | | | | |
|---|---|---|---|---|---|---|
| | after sliding test | | | | | |
| | (mm) | | | hardness | crack | T1 + T2 |
| | 10,000 | 40,000 | 200,000 | (Hv) | (μm) | (μm) |
| Ex. 1 | 0.11 | 0.13 | 0.14 | 102 | 10.8 | 1.10 |
| Ex. 2 | — | 0.10 | — | 98 | 9.8 | 0.60 |
| Ex. 3 | — | 0.12 | — | 99 | 9.1 | 0.70 |
| Ex. 4 | — | 0.13 | — | 108 | 9.1 | 1.05 |
| Ex. 5 | — | 0.12 | — | 106 | 9.8 | 1.50 |
| Ex. 6 | — | 0.13 | — | — | — | 1.10 |
| Ex. 7 | — | 0.11 | — | — | — | 1.10 |
| Ex. 8 | — | 0.12 | — | — | — | 2.05 |
| Ex. 9 | — | 0.14 | — | 108 | 11.3 | 2.10 |
| Ex. 10 | — | 0.10 | — | 116 | 15.4 | 2.50 |
| Ex. 11 | — | 0.14 | 0.18 | 103 | — | 1.10 |

TABLE 4

| | wear scar width | | | | | |
|---|---|---|---|---|---|---|
| | after sliding test | | | | | |
| | (mm) | | | hardness | crack | T1 + T2 |
| | 10,000 | 40,000 | 200,000 | (Hv) | (μm) | (μm) |
| Comp. 1 | 0.15 | 0.88 | — | 112 | 7.8 | 1.00 |
| Comp. 2 | 0.10 | 0.78 | — | 133 | 48.1 | 3.00 |
| Comp. 3 | — | 0.15 | 0.14 | 103 | 7.3 | 1.50 |
| Comp. 4 | 0.11 | 0.15 | 0.16 | 136 | 37.1 | 3.50 |
| Comp. 5 | — | 0.60 | — | 91 | 3.9 | 0.10 |
| Comp. 6 | 0.16 | 0.57 | — | 98 | 9.4 | 0.50 |
| Comp. 7 | — | 0.19 | 0.85 | 115 | 17.3 | 1.00 |
| Comp. 8 | — | 0.15 | 0.31 | 132 | 29.1 | 2.00 |
| Comp. 9 | — | 0.48 | — | 96 | — | 1.10 |
| Comp. 10 | — | 0.61 | — | 100 | — | 1.10 |
| Comp. 11 | | 0.79 | — | 99 | — | 1.10 |
| Comp. 12 | — | 0.32 | — | 100 | — | 0.55 |
| Comp. 13 | 0.10 | 0.10 | 0.14 | 133 | 45.1 | 3.10 |
| Comp. 14 | — | 0.11 | — | 133 | 44.4 | 3.30 |
| Comp. 15 | — | 0.27 | — | — | — | 0.60 |
| Comp. 16 | — | 0.16 | 0.21 | | | 1.10 |

Comparative Examples 1 and 2 are examples of most general plating specifications for connector terminals, wherein the Ni plating, the AuCo alloy plating and the film formed by the sealing process are sequentially formed on the base metal. In these comparative examples, the base metal of copper was exposed by wear scars after forty hundred thousand reciprocating motions, so that wear resistance was bad. In addition, even if the nickel plating was thick as Comparative Example 2, wear resistance was hardly improved, and only disadvantages, such as the rise in apparent hardness and the deterioration in workability, which is the increase of the crack width in bending work, were increased.

Comparative Examples 3 and 4 are examples of typical plating specifications which are put to practical use when a high wear resistance is required. In these comparative examples, the Ni plating, the PdNi alloy plating, the AuCo alloy plating and the film formed by the sealing process are sequentially formed on the base metal. In these comparative examples, the progress of wear was not observed even after two hundred thousand reciprocating motions, so that it was verified that wear resistance was excellent.

Comparative Examples 5 through 8 are examples of plating specifications which are intended to improve corrosion resistance and heat resistance, wherein the NiP alloy plating, the AuCo plating and the film formed by the sealing process are sequentially formed on the base metal. It was estimated that the NiP alloy plating has a high wear resistance since it substantially has the same hardness as that of a PdNi alloy plating. However, if the Ni alloy plating (Comparative Example 6) and the PdNi alloy plating (Comparative Example 3) having the same thickness were compared with each other, the wear resistance of the Ni alloy plating was far worse than that of the PdNi alloy plating, and the crack width of the Ni alloy plating in bending was remarkably increased. It is considered that the reason for this is that the NiP alloy plating is a brittle film having a low toughness.

From the results in Comparative Examples 9 through 11 and Examples 1 and 11, it can be found that wear resistance is remarkably improved if the first plating layer is the Ni plating layer and if the Ni plating is carried out in a sulfamic acid bath or a Watt's bath containing a primary brightener. The principle that wear resistance is thus improved is not clear. However, since the common point between compositions of the plating baths is that sulfur compounds are contained in the compositions of the plating baths, it is considered that the toughness of the whole film is improved if an eutectoid of sulfur content exists in the plating film.

From the results in Examples 1 through 11 and Comparative Examples 12 through 15, the wear resistance and bending workability in Examples 1 through 11 are excellent. If the first plating layer is too thick so as to have has a thickness of 3 μm as Comparative Examples 13 and 14, the function of improving wear resistance is saturated, and the bending workability is deteriorated. On the other hand, the first plating layer is too thin so as to have a thickness of 0.1 μm as Comparative Example 15, wear resistance is deteriorated. Therefore, the thickness (T1) of the first plating layer is preferably in the range of 0.5 μm to 2.5 μm.

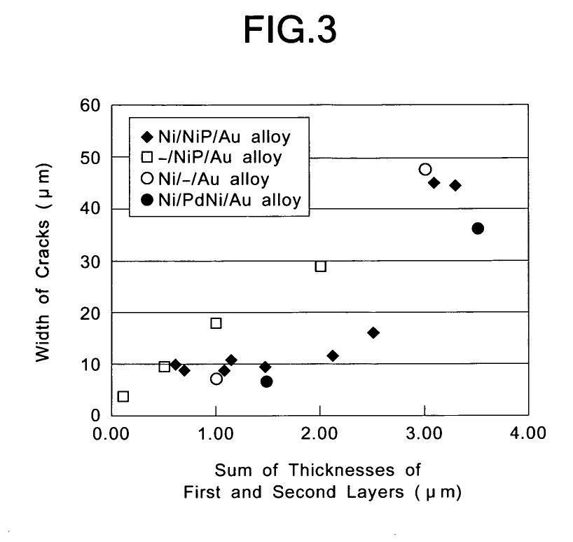

FIG. 3 shows the relationship between the sum (T1+T2) of the thicknesses of the first and second plating layers, and the width of cracks produced in bending. It can be found that the width of cracks is small when the sum (T1+t2) is not greater than 2.5 μm, whereas the width of cracks abruptly increases when the sum (T1+T2) exceeds 2.5 μm. Therefore, the sum (T1+T2) of the thicknesses of the first and second plating layers is preferably in the range of 0.6 μm to 2.5 μm.

Comparative Example 16 is an example wherein the sealing processes for forming the fourth layer is not carried out. It can be found that wear resistance in this comparative example is worse than that in Example 1.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

1. A metal member comprising:
a metal base;
a first plating layer of nickel and unavoidable impurities, said first plating layer being formed on the metal base;
a second plating layer of nickel, phosphorus and unavoidable impurities, said second plating layer being formed on said first plating layer;
a third plating layer of a gold alloy and unavoidable impurities, said third plating layer being formed on said second plating layer; and
a fourth layer formed on said third plating layer by a sealing process,
whereas said first plating layer has a thickness of 0.5 to 2.5 μm, and said second plating layer has a thickness of 0.05 to 0.5 μm, the sum of the thicknesses of the first and second plating layers being in the range of from 0.60 μm to 2.5 μm, and said third plating layer having a thickness of not less than 0.05 μm.

2. A metal member as set forth in claim 1, wherein said first plating layer is a nickel plating layer formed by a sulfamic acid bath or by a Watt's bath to which a primary brightener containing a sulfur content is added.

3. An electric contact comprising:
a first terminal of a metal member as set forth in claim 1; and
a second terminal contacting said first terminal.

4. An electric contact comprising:
a first terminal of a metal member as set forth in claim 2; and
a second terminal contacting said first terminal.
